(19) United States
(12) Patent Application Publication
(10) Pub. No.: US 2010/0083515 A1
(43) Pub. Date: Apr. 8, 2010

(54) PT Ruler

(76) Inventor: Paul Thomas Wood, Mandeville, LA (US)

Correspondence Address: Paul Thomas Wood, 444 Bill Drive, Mandeville, LA, 70448, US

(21) Appl. No.: 12/247,089

(22) Filed: Oct. 7, 2008

(51) Int. Cl. B43L 7/00

(52) U.S. Cl. 33/483

(57) ABSTRACT

The “PT RULER”, an improvement on the typical triangular architectural scale ruler, in the following ways: 1) improvement of the view angle of the ruler eliminating the need for the user to “bend over” the ruler, 2) improvement of the arrangement or placement of the scales on the ruler to enable the user to simply “rotate” the ruler to view related scales, 3) improvement of the color of the individual scales, with each scale having its own distinctive color, 4) improvement of the font of each individual scales, using different font sizes for better readability, and 5) improvement of the ruler by changing the 16 scale with a 16″ on center scale (based on ¼″ scale).

### TECHNICAL FIELD AND INDUSTRIAL APPLICABILITY OF THE INVENTION

This invention relates to the improvement of an existing tool, the triangular shaped architectural scale ruler. The present invention, the “PT RULER”, relates to an improved orientation of scales for easy viewing, an improved grouping of scales, an improved color of scales, improved font of each actual scale, and the addition of a 16″ on center scale in place of the 16 scale. Since the invention has nothing to do with ornamental design, but rather with the utility of the tool, the application is for a utility patent.

### BACKGROUND OF THE INVENTION

CURRENT (TRADITIONAL) ARCHITECTURAL SCALE RULER

Presently, the triangular architectural scale ruler has the following characteristics:

VIEW: It is designed to be viewed as in FIG. 6 of drawing, so that the scale being viewed is the scale that is the furthest away from the person viewing the scale. If lines are drawn with ruler, they are drawn using the side of the ruler furthest from the person viewing.

CURRENT (TRADITIONAL) SCALE ARRANGEMENT: The scales are arranged so that similar scales are on one side of the ruler. So the ⅛″, ¼″, ½″, and 1″ scales are on one of the triangular sides, the 3/32″, 3/16″, and 16″ scales are on another one of the triangular sides, and the ⅜″, ¾″, 1½″, and 3″ scales are on the final triangular side.

CURRENT (TRADITIONAL) SCALE COLOR: The color of the scales is typically black, with each of the triangular sides' mid section being colored, or with each of the three triangular sides being colored one color.

CURRENT (TRADITIONAL) SCALE FONT: The font size of each of the scales is typically the same for each individual scale.

CURRENT (TRADITIONAL) 16″ ON CENTER SCALE: There is no scale for 16″ on center on the typical triangular architectural scale ruler.

### BRIEF SUMMARY OF THE INVENTION—“PT RULER”

The “PT RULER” uses the basic shape and measurement of the traditional triangular architectural scale ruler. However, the “PT RULER” improves on the existing architectural scale ruler by providing a better view angle, a better grouping of scales so that similar scales can be viewed by simply rotating the ruler, better scale colors so that each scale has its unique color, different font sizes on each ruler to facilitate quick measurement location, and the addition of the 16″ on center scale (switched with the “16” scale).

### DESCRIPTION OF THE VIEWS OF THE DRAWING

FIG. 1 is an “end view” of the ruler, and shows the end dimensions of the ruler.

FIG. 2 is an elevation view of the ruler, and shows the actual length of the ruler. The angle of the view is illustrated in FIG. 5 by an arrow with the “2” next to the arrow. This is the view one has when using the ¼″ scale.

FIG. 3 is an elevation view of the ruler. The angle of the view is illustrated in FIG. 5 by an arrow with the “3” next to the arrow. This is the view one has when using the 16″ on center scale.

FIG. 4 is an elevation view of the ruler. The angle of the view is illustrated in FIG. 5 by an arrow with the “4” next to the arrow. This is the view one has when viewing the 3/16″ scale.

FIG. 5 is an “end view” of the ruler, similar to the view in FIG. 1. This FIG. 5 illustrates the positioning of the scales on the ruler, and illustrates the angle of view of FIG. 2, FIG. 3, and FIG. 4.

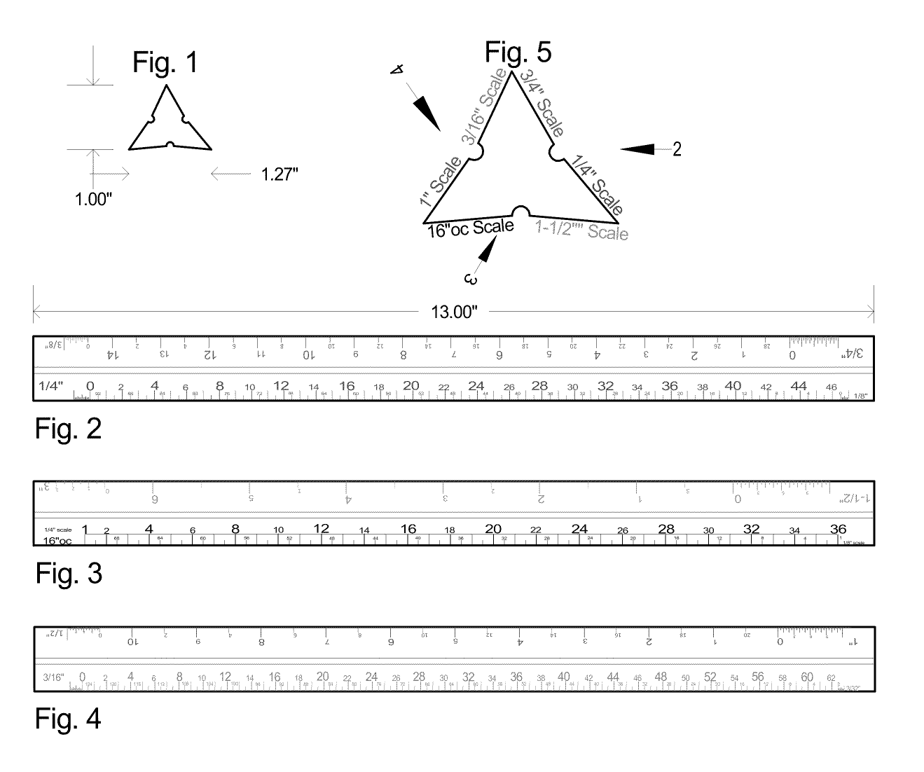

### DETAILED DESCRIPTION OF THE INVENTION

This invention, the “PT RULER”, has to do with improvements on the following aspects of the traditional triangular architectural scale ruler: improved VIEW, improved SCALE ARRANGEMENT, improved SCALE COLOR, improved SCALE FONT, and the addition of the 16″ on center scale (switched with 16 scale). These improvements are described as follows:

VIEW

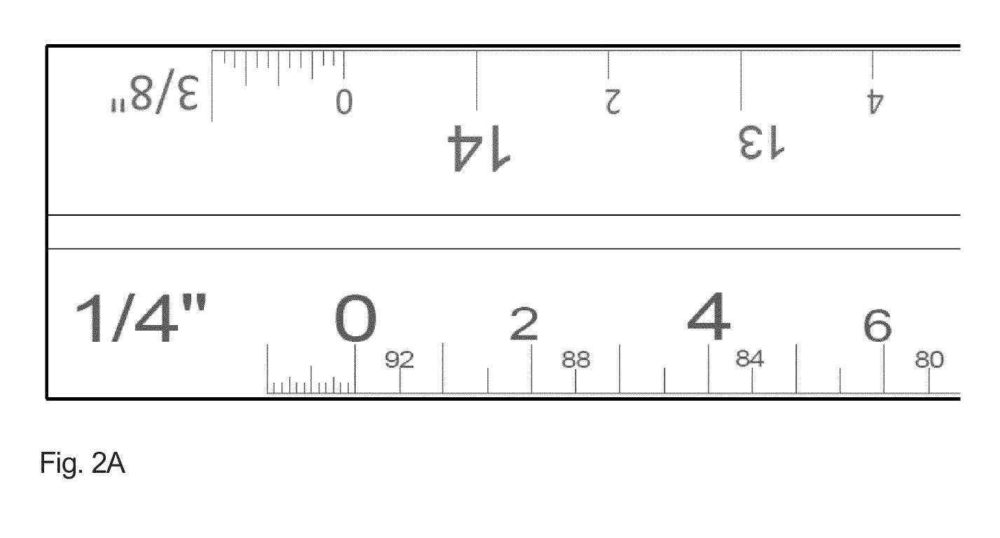

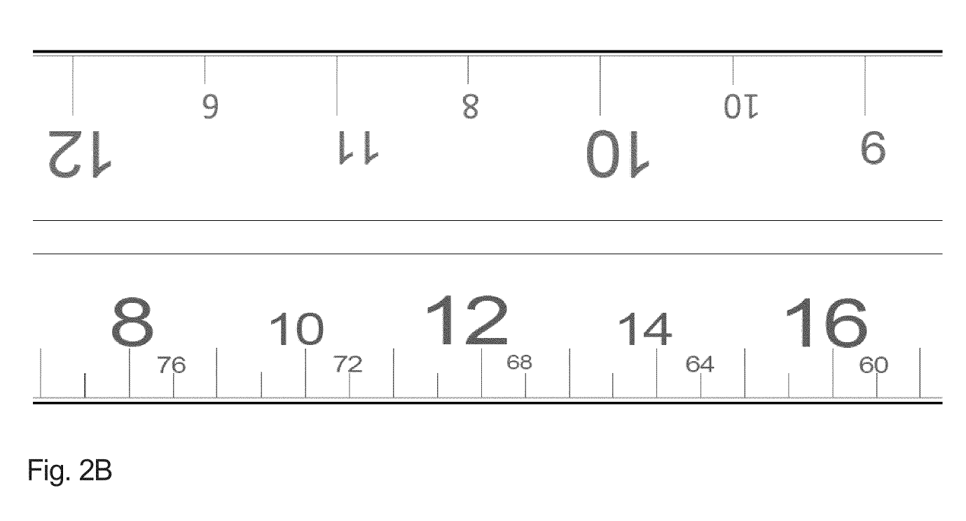

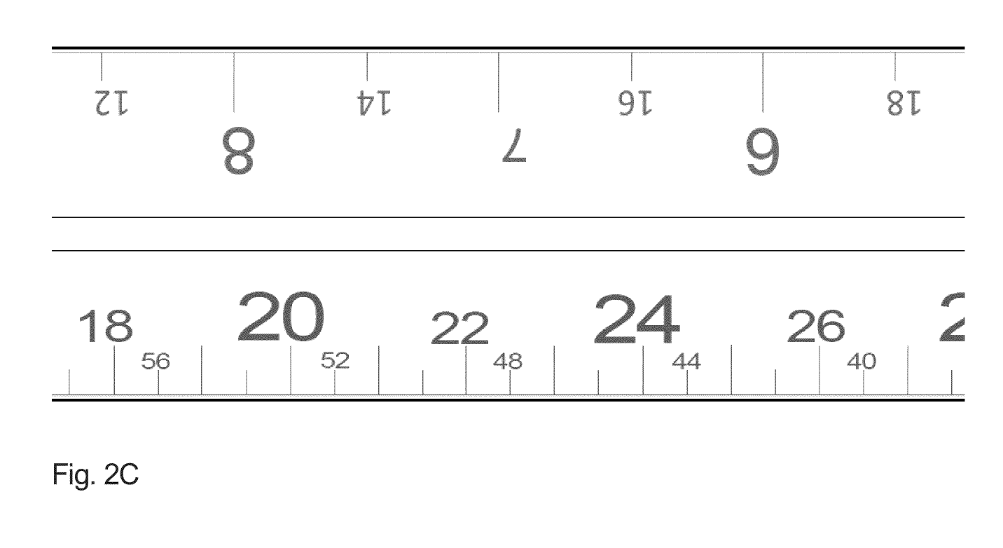

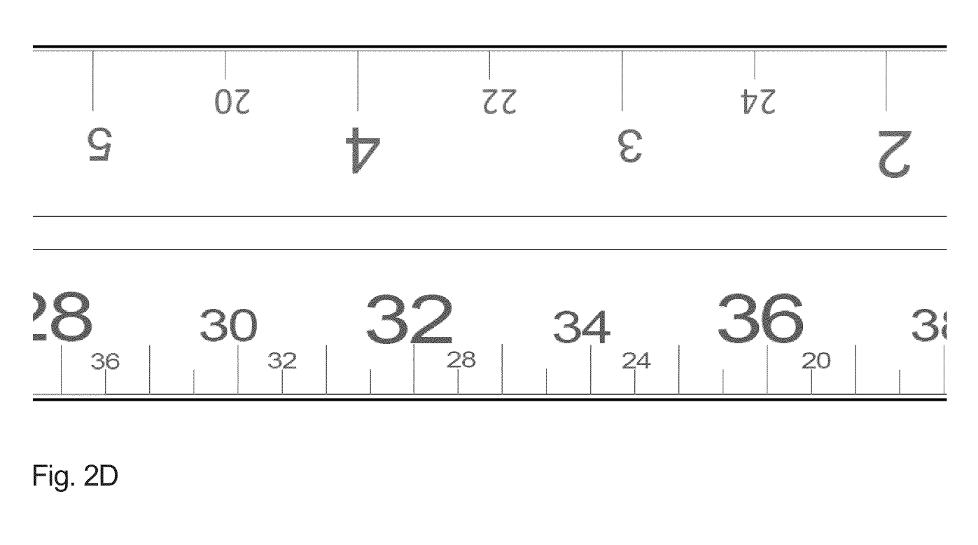

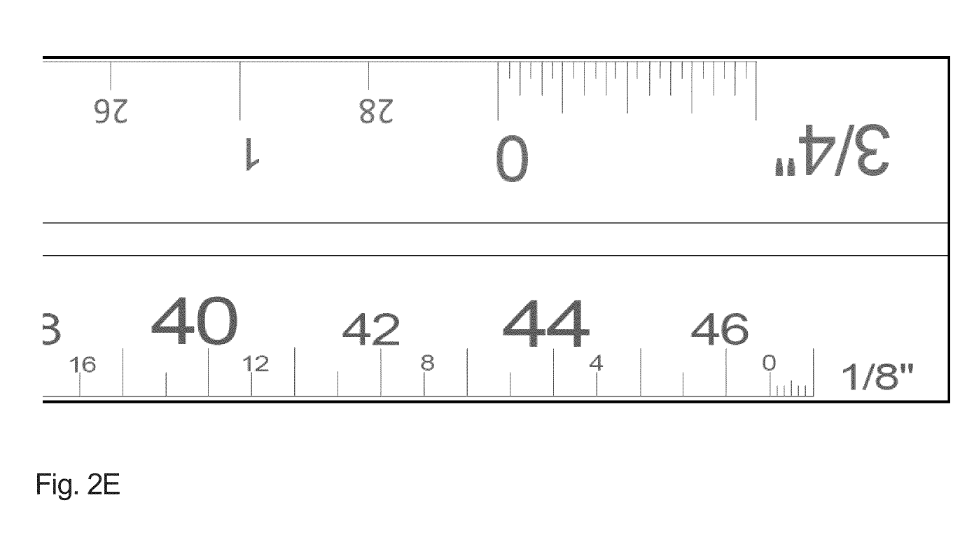

Traditionally, an architect, draftsman, contractor, or layman views the scale on the side furthest away from him/her, as illustrated in FIG. 6, requiring the architect to “lean over” the ruler. With the scale oriented on the ruler as in FIG. 2, the architect views the scale which is closest to him/her, as illustrated in FIG. 7, so that the architect does not have to “lean over”.

SCALE ARRANGEMENT

When an architect, draftsman, contractor, or layman uses an architectural scale ruler to view a scaled architectural drawing, he/she usually uses scales that are related.

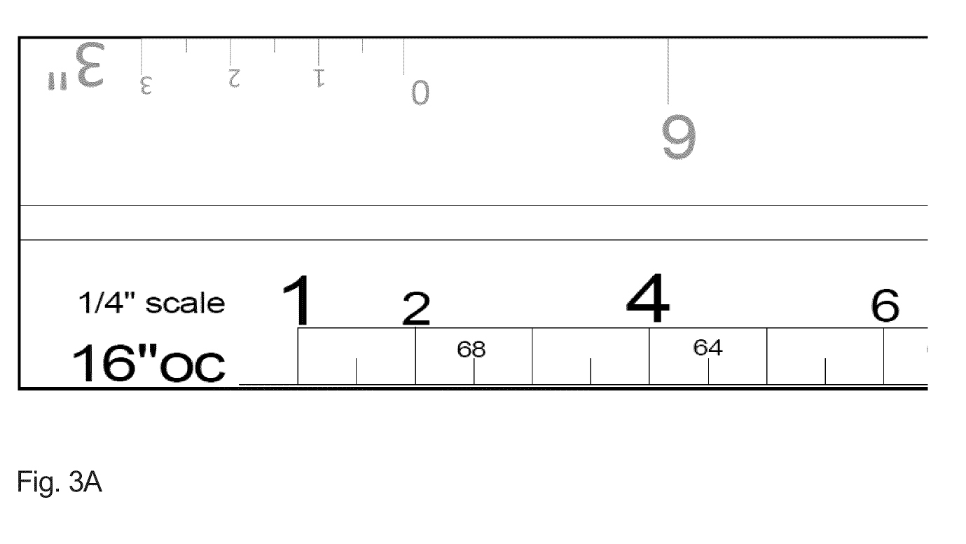

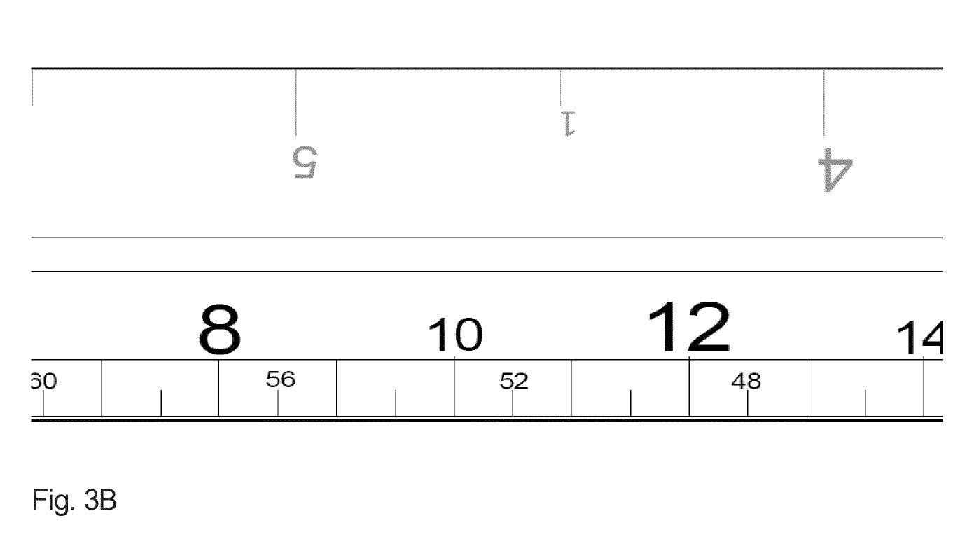

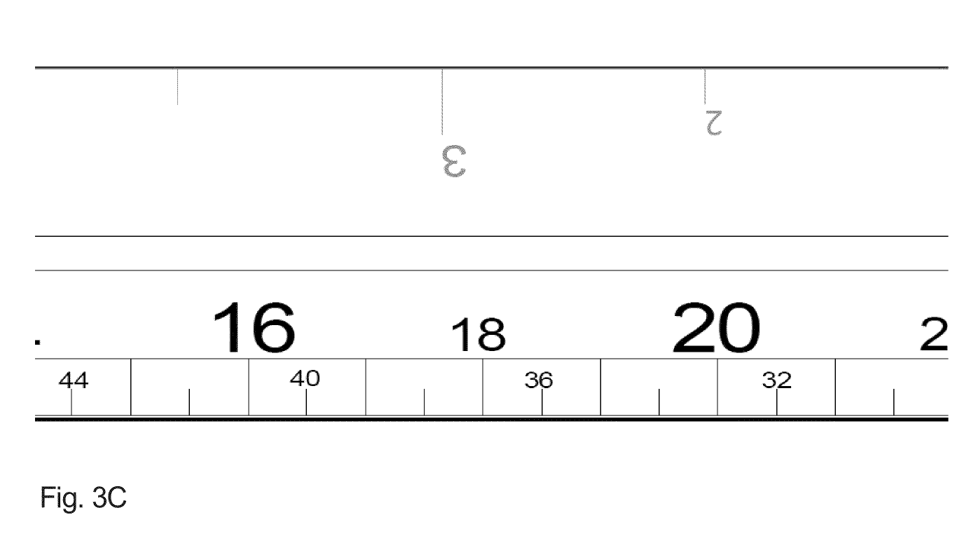

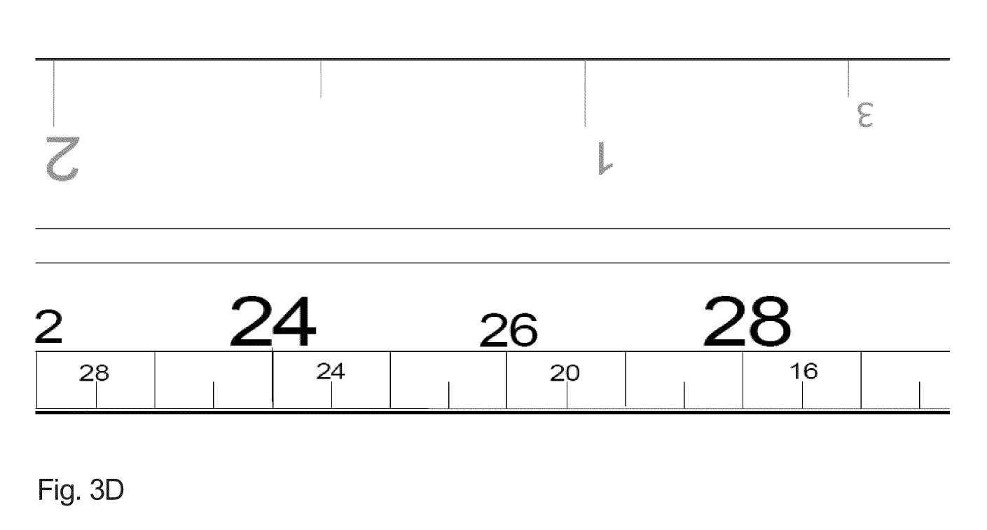

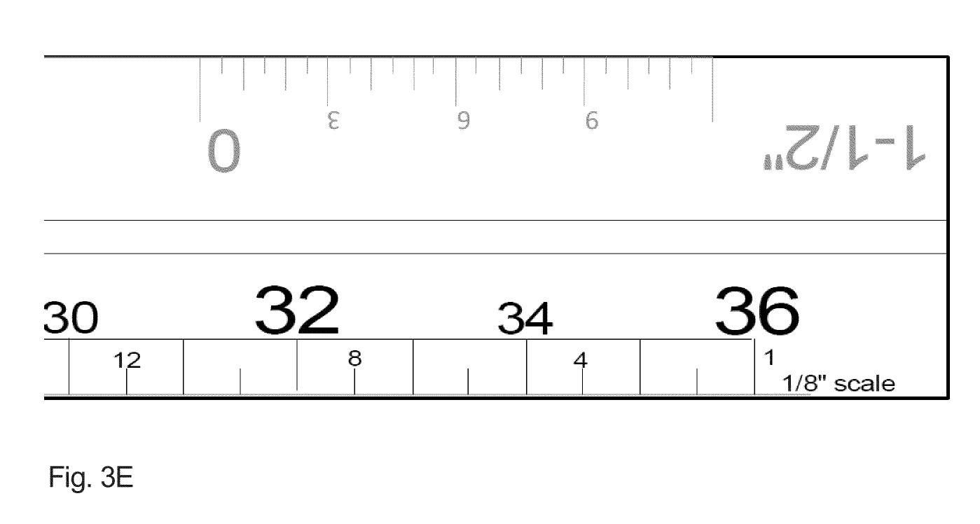

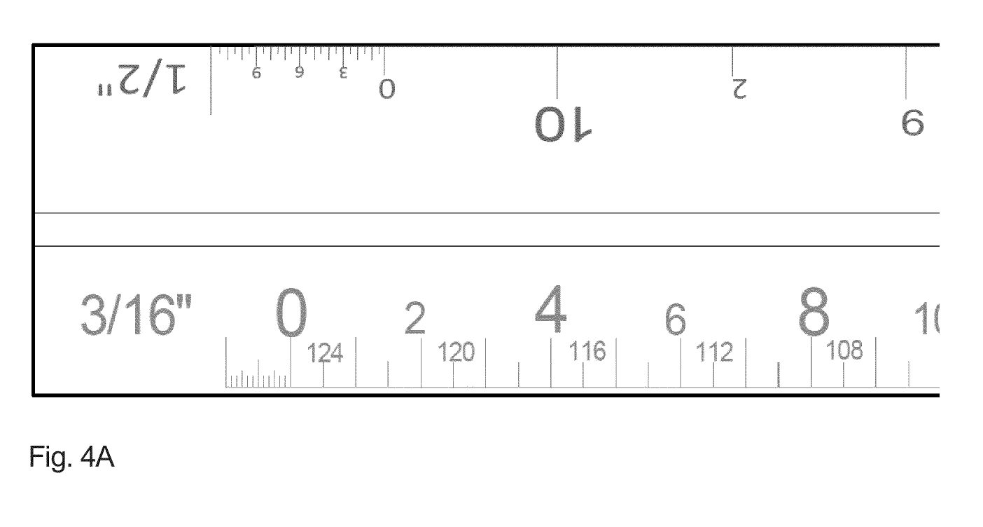

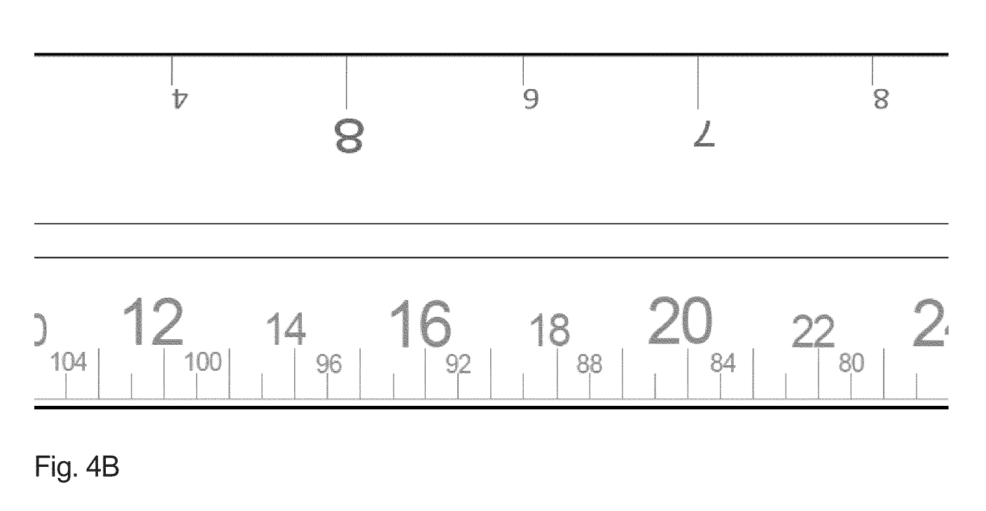

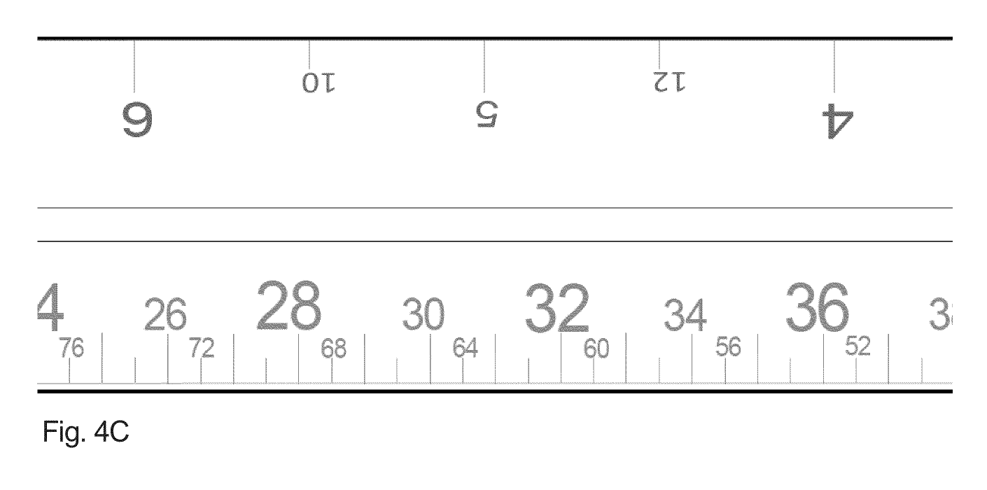

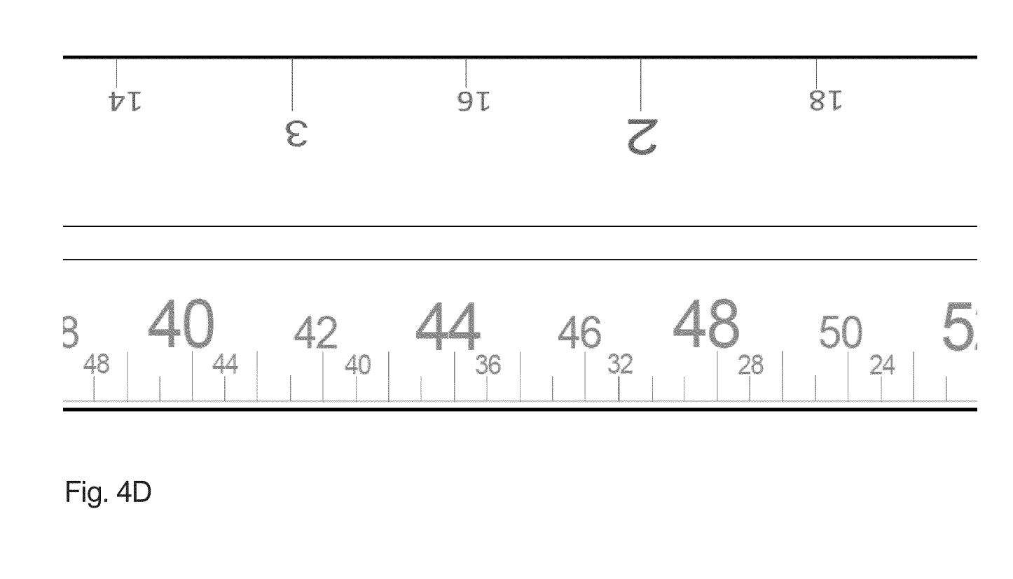

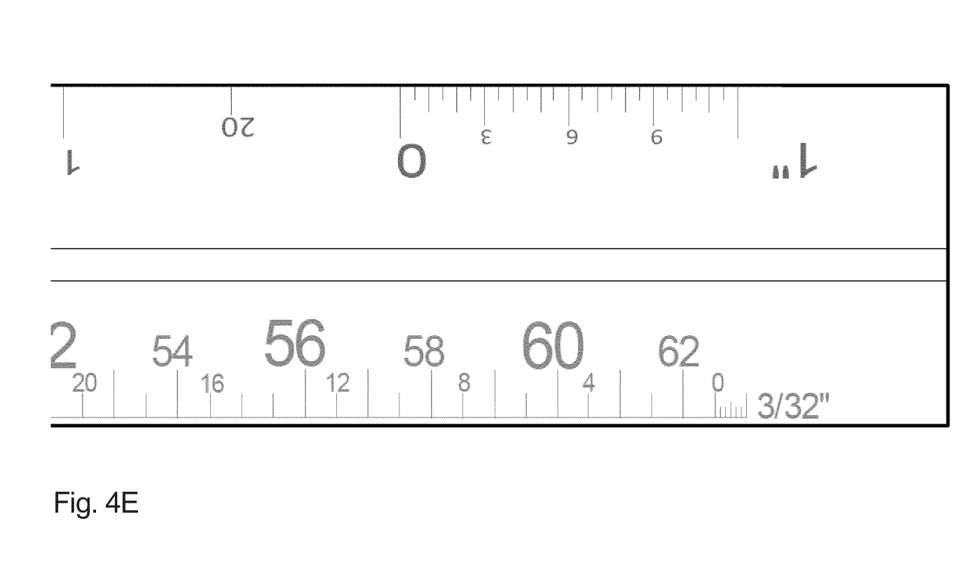

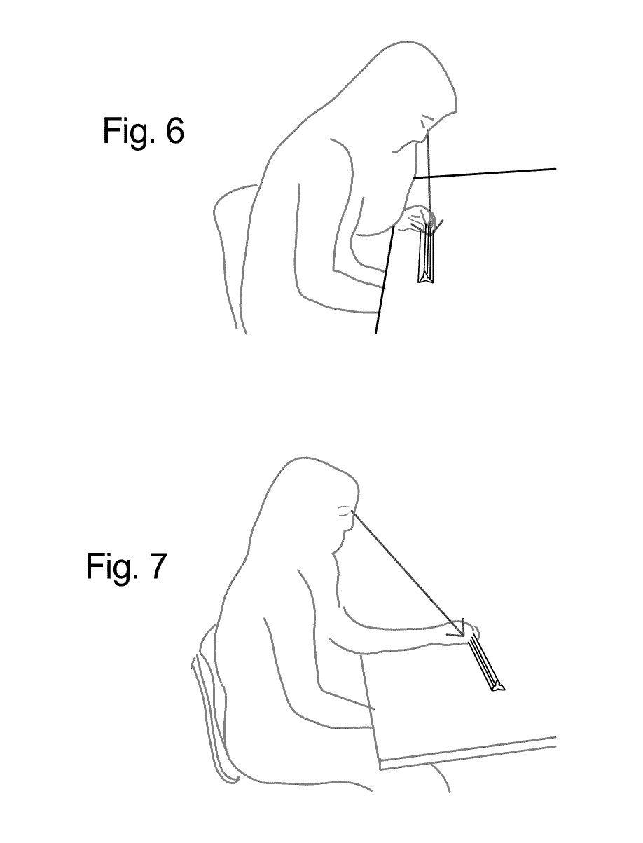

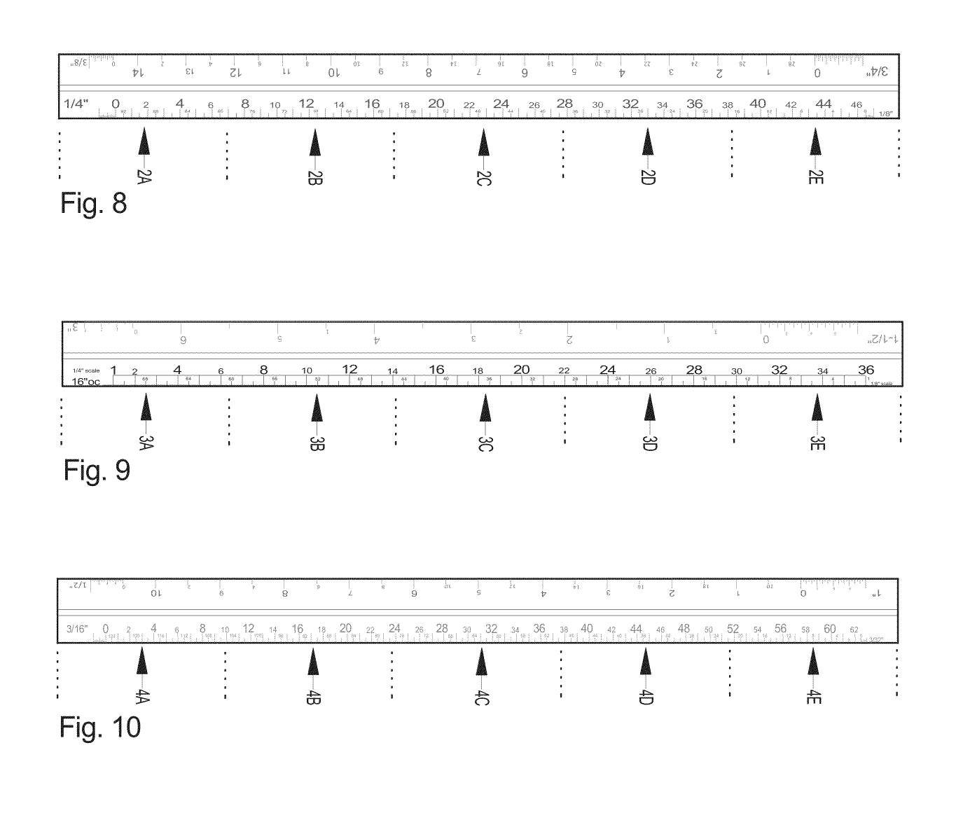

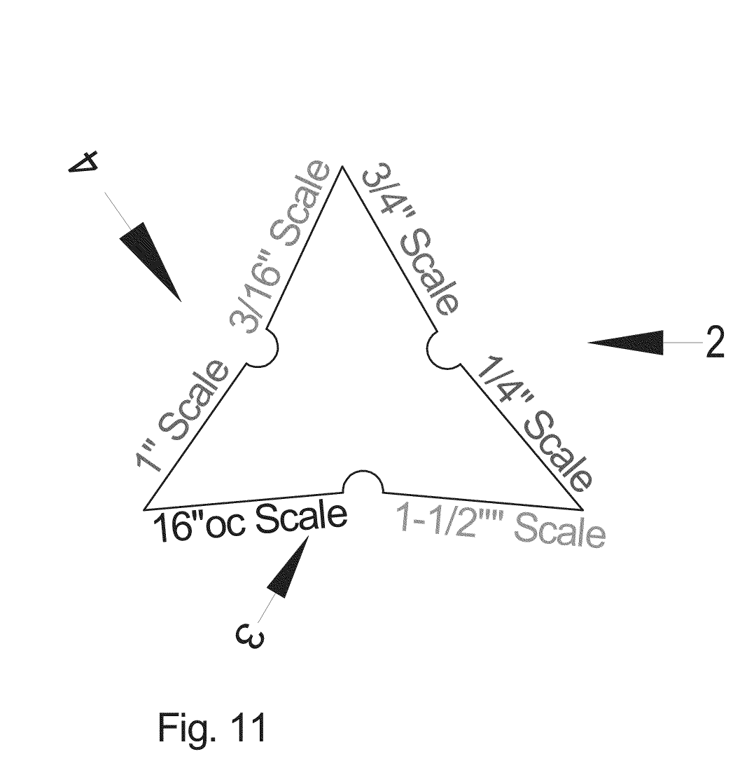

For instance, when he/she is viewing the plan or elevation views of architectural drawings, he/she typically uses the ¼″, ⅛″, 3/16″, and hopefully a 16″ on center scale. The typical triangular architectural ruler allows him/her to “rotate” between the ¼″ and 3/16″ scales, but provides no 16″ on center scale. The “PT RULER” provides for him/her to simply rotate the ruler to go back and forth from the ¼″ scale, the 16 inch on center scale, and the 3/16″ scale. Note: the 16″ on center scale is based on a ¼″ scale (this scale is inserted in place of the 16 scale, or the scale used to measure actual inches). To illustrate, let's say that he/she is viewing the ruler as in FIG. 2 so that the ¼″ scale is in view. He/she rotates the ruler once and sees the 16″ on center scale, as in FIG. 3. If he/she rotates the ruler again, he/she sees the 3/16″ scale, as in FIG. 4. And so all related scales are viewed by simply rotating the ruler.

When he/she is viewing the detailed or enlarged views of architectural drawings, he/she typically uses the ⅜″, ¾″, 1″, 1½″, and 3″ scales. In order to use all of these scales, he/she must “flip” the ruler end to end. The “PT RULER” provides for him/her to simply rotate the ruler to go back and forth from the ⅜″, ¾″, 1″, 1½″, and 3″ scales.

SCALE COLOR

The color of the scales on a typical architectural ruler is black, with each of the triangular sides' mid section being colored, or with each of the three triangular sides being colored one color. The “PT RULER” uses only one color per scale: the ¼″ scale is red, the 16″ on center scale is black, the 3/16″ scale is green, the ¾″ scale is blue, the 1″ scale is purple, and the 1½″ scale is orange. Since each scale has its own individual color, he/she makes less mistakes using the wrong scale.

SCALE FONT

On a typical architectural scale ruler, the fonts used for each scale are the same size. However, on the “PT RULER”, the font sizes are varied for ease of viewing. For instance, in FIG. 2, the ¼″ scale has larger fonts for 0,4,8,12,16,20, etc, which allows for better readability of the measurement.

16″ ON CENTER SCALE

On a typical architectural scale ruler, there is no provision to measure 16″ on center, such as for joists or rafters that are placed 16″ on center. The “PT RULER” calls for the insertion of a 16″ on center scale (based on a ¼″ scale) in place of the 16 scale (scale to measure actual inches). And so, as an example, if an architect wants to draw rafters in a roof plan at 16″ on center in ¼″ scale, then he/she can use the 16″ on center scale on the “PT RULER”. Or, if an estimator wants to count the number of joists required at 16″ on center spacing, he/she can use the same scale.

1. VIEW
The view angle of the “PT RULER” is an improvement in that it allows for a better angle of view as illustrated in FIG. 7, allowing for the user to view the scale without bending over. This is in contrast to the view angle of the traditional triangular architectural scale ruler as illustrated in FIG. 6.

2. SCALE ARRANGEMENT
The scale arrangement of the “PT RULER” enables the user to use related scales by simply rotating the ruler, instead of having to “flip end to end”.

3. SCALE COLOR
Each scale is assigned its own color, so that the user is more likely to use the correct scale.

4. SCALE FONT
The “PT RULER” calls for the use of different font sizes on each scale, providing for better readability.

5. 16″ ON CENTER SCALE
The “PT RULER” calls for the insertion of a 16″ on center scale (base on ¼″ scale), which scale architects, draftsmen, contractors, and laymen typically want to use when drawing or reading architectural drawings.
